(19) United States
(12) Patent Application Publication
(10) Pub. No.: US 2026/0254404 A1
(43) Pub. Date: Aug. 27, 2026

(54) METHODS AND SYSTEMS FOR ROTATIONAL COMPENSATION IN SOLAR TRACKER SYSTEMS

(71) Applicant: Nextpower LLC, Fremont, CA (US)

(72) Inventors: Nathan Malone, Fremont, CA (US); Alessio Orsini, Menlo Park, CA (US)

(21) Appl. No.: 19/533,896

(22) Filed: Feb. 9, 2026

Related U.S. Application Data
(60) Provisional application No. 63/762,295, filed on Feb. 24, 2025.

(51) Int. Cl. H02S 20/32; F24S 30/425; H02S 30/10

(52) U.S. Cl. CPC H02S 20/32; F24S 30/425; H02S 30/10

(57) ABSTRACT

Methods and systems for controlling a solar tracker system include solar tracker systems including a controller configured for determining a sun elevation angle, determining a solar array backtracking angle based on the sun elevation angle, determining a torque tube twist angle relative to the solar array backtracking angle, determining an offset angle for the solar tracker based on the torque tube twist angle relative to the solar array backtracking angle, and in response to determining the offset angle for the solar tracker, controlling the solar tracker to rotate a torque tube of a solar array to the offset angle.

### RELATED MATTERS

This application claims the benefit of U.S. Provisional Patent Application No. 63/762,295, filed Feb. 24, 2025. The entire contents of each of these applications are incorporated herein by reference.

### TECHNICAL FIELD

This disclosure relates generally to solar power generation systems, and more particularly, to methods and systems for minimizing solar tracking error for solar arrays within a solar tracking system.

### BACKGROUND

Solar panels are generally composed of an array of solar cells, which are interconnected to each other. The cells are often arranged in series and/or parallel groups of cells in series. Solar cells and solar panels are typically more efficient in sunny conditions when oriented towards the sun at a certain angle (e.g., angled to present a solar panel surface area that is normal or perpendicular to the direction of incident rays of sunlight, a “normal incidence angle”). Many solar panel systems are designed in combination with solar trackers, which enable the solar panels or solar modules to follow the sun's trajectory across the sky from east to west throughout a typical day in an attempt to maximize the electrical generation capabilities of the solar panel systems.

Typically, a relatively large number of solar cells are arranged in an array to generate energy in sufficient amounts to be usable, for example as part of an energy grid. As a result, solar trackers have been developed that are quite large, spanning hundreds of feet in length and including hundreds of individual solar modules that are mechanically coupled to support structures. An array of solar trackers may be formed of a plurality of solar tracker rows that are oriented generally parallel to each other, often in a north-to-south configuration, which may facilitate rotating or tilting the solar modules throughout the day to attempt to follow the trajectory of the sun and maximize the energy produced.

The general trend in the solar tracker industry is turning toward longer trackers and larger modules to harvest solar energy, however, solar trackers depend on precise positioning to maximize energy harvesting. Torque tubes of the solar trackers are designed have some flexibility. The flexibility is beneficial to accommodate changing terrain, and minor misalignments in support and mounting structures. Such flexibility has some disadvantages, though. The flexibility may permit twisting of the torque tube. As a drive mechanism controls the rotation of torque tube, the portion of the torque tube distal from the drive mechanism may not rotate the same angle as the portion proximal to the drive mechanism due to twisting of the tube. The amount of twist may vary along the length of the torque tube as the torque tube extends further from its drive mechanism. Since the rotation of the torque tube controls the rotation of the solar modules mounted on the torque tube, the orientation of the solar modules may vary along the length of the torque tube. If the solar modules proximal to the drive mechanism are oriented at an angle that produces the maximum yield, the solar modules distal from the drive mechanism may be at a different angle, which is suboptimal. Larger amounts of twist angles result in lower energy yield. The present disclosure seeks to address the shortcomings of prior tracker systems.

### SUMMARY

In general, the present disclosure relates to support structures for solar arrays within a solar tracking system. In one example, a solar tracker system may include a plurality of solar tracker rows. A one of the plurality of solar tracker rows may include a plurality of support piers, a torque tube extending along the solar tracker row rotatably supported on the plurality of support piers, a plurality of solar modules coupled to the torque tube, and a drive motor configured to cause the torque tube to rotate. The solar tracker system may further include a controller configured to determine a sun elevation angle, determine a desired rotational angle of the plurality of solar modules based on the sun elevation angle, determine a torque tube twist angle for the one of the solar tracker rows using the desired rotational angle, determine an offset angle for the one of the solar tracker rows based on the torque tube twist angle, and in response to determining the offset angle, controlling the one of the solar tracker rows to rotate the torque tube to the desired rotational angle adjusted by the offset angle.

Additionally or alternatively, a first solar module of the plurality of solar modules may be located nearest to the drive motor and a last solar module of the plurality of solar modules may be located farthest from the drive motor.

Additionally or alternatively, the torque tube twist angle may correspond to a twist angle of the last solar module.

Additionally or alternatively, the torque tube twist angle may increase as the distance between the first solar module and the last solar module increases.

Additionally or alternatively, the torque tube twist angle may increase as a number of solar modules between the first solar module and the last solar module increases.

Additionally or alternatively, the torque tube twist angle may be in a range of 0.2-degrees to 3-degrees.

Additionally or alternatively, the first solar module of the plurality of solar modules may have a twist angle of zero-degrees.

Additionally or alternatively, the offset angle may be a rotational angle adjustment of the first solar module away from the desired rotational angle that will move an average rotational angle between the first solar module and the last solar module closer to the desired rotational angle.

Additionally or alternatively, the offset angle may be a rotational angle adjustment of the first solar module away from the desired rotational angle that will move a calculated average rotational angle between the first solar module and the last solar module to the desired rotational angle.

Additionally or alternatively, determining the offset angle may include evaluating the following expression:

$$Offset angle {θ}_{3} = - \frac{1}{3} \frac{{T}_{dw} {L}_{tracker}}{{( G * J )}_{TT}}$$

where Tdw represents deadweight torque, Ltracker represents a length of the torque tube, G represents a modulus of rigidity of the torque tube, and J represents a polar moment of inertia of a cross section of the torque tube.

Additionally or alternatively, deadweight torque may be an amount of torque required to begin rotation of the torque tube from a stationary position.

Additionally or alternatively, the offset angle may include ±20% of the calculated offset angle θ.

Additionally or alternatively, the desired rotational angle may correspond to a calculated backtracking angle.

In another example, a method of controlling a solar tracker via a controller having a memory with instructions for determining an offset angle stored thereon may include determining a sun elevation angle, at the controller, determining a solar array backtracking angle based on the sun elevation angle, at the controller, determining a torque tube twist angle relative to the solar array backtracking angle, at the controller, determining the offset angle for the solar tracker based on the torque tube twist angle relative to the solar array backtracking angle, at the controller, and in response to determining the offset angle for the solar tracker, controlling the solar tracker, via the controller, to rotate a torque tube of a solar array to the offset angle.

Additionally or alternatively, determining the offset angle may include evaluating the following expression:

$$Offset angle {θ}_{3} = - \frac{1}{3} \frac{{T}_{dw} {L}_{tracker}}{{( G * J )}_{TT}}$$

where Tdw represents deadweight torque, Ltracker represents a length of the torque tube, G represents a modulus of rigidity of the torque tube, and J represents a polar moment of inertia of a cross section of the torque tube.

Additionally or alternatively, deadweight torque may be an amount of torque required to begin rotation of the torque tube from a stationary position.

Additionally or alternatively, the torque tube twist angle may be 0-degrees near a drive motor.

Additionally or alternatively, the torque tube twist angle may increase along a length of the torque tube due to an increased length of the torque tube and a weight of a plurality of solar modules of the solar array.

Additionally or alternatively, the offset angle may include ±20% of the calculated offset angle θ.

Additionally or alternatively, the determined backtracking angle may correspond to a desired rotational angle.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a schematic, perspective view of a torque tube illustrating a torque tube twist angle;

FIG. 4A is a schematic view of a solar tracker system illustrating a torque tube twist angle;

FIG. 4B is a schematic view of the solar tracker system of FIG. 4A, illustrating a torque tube twist when the solar tracker system has been offset;

FIG. 5 is a graph showing an average plot twist error;

FIG. 6 is a graph showing an annual yield loss; and

FIG. 7 is a flow chart illustrating a method of controlling a solar tracker in accordance with the present disclosure.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

During operation of solar trackers, torque is applied to a torque tube to turn (e.g., orient) solar modules such that the solar modules follow the sun's trajectory across the sky from east to west throughout a typical day to try and maximize the electrical generation capabilities of the solar tracker systems. However, the torque tubes of the solar trackers can span significant lengths, which may result in the torque tube twisting along its length, thereby leading to larger torque tube twist angles of the torque tube relative to the torque tube angle proximal the drive mechanism the further the torque tube is from a motor pier. In other words, flexibility of the torque tube, along with the length of the torque tube, may result in the torque tube having varied rotational angles along its length. In such cases, the attached solar modules further include varied rotational angles, thereby leading to suboptimal energy yield. Torque tube twist is a common issue present in the solar tracker industry. The offset algorithm disclosed herein may help mitigate the problem where it is present.

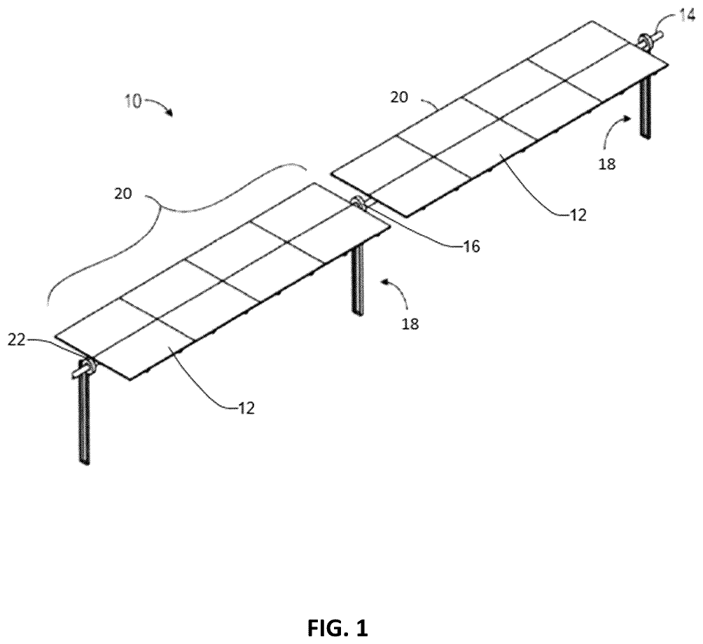

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

Since there is often just a single drive mechanism 16 for a row of solar trackers, the specifications for the torque tube 14 may desire to reduce twist of the torque tube 14 along its length. Any twist would result in the solar modules 12 being oriented differently from what is desired, and thus again reduce the output and efficiency of the solar tracker 10, particularly, as the solar tracker 10 is rotated towards the extreme angles of permitted range (e.g., +/−75 degrees or more). However, the desired flexibility in the torque tube for several purposes also leads to the torque tube being flexible enough to twist along its length as it extends away from the drive mechanism.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

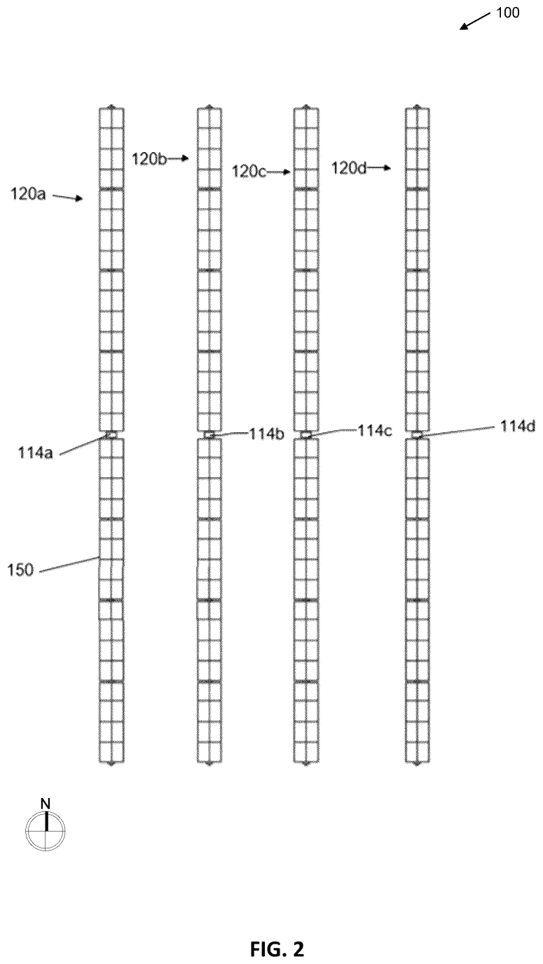

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

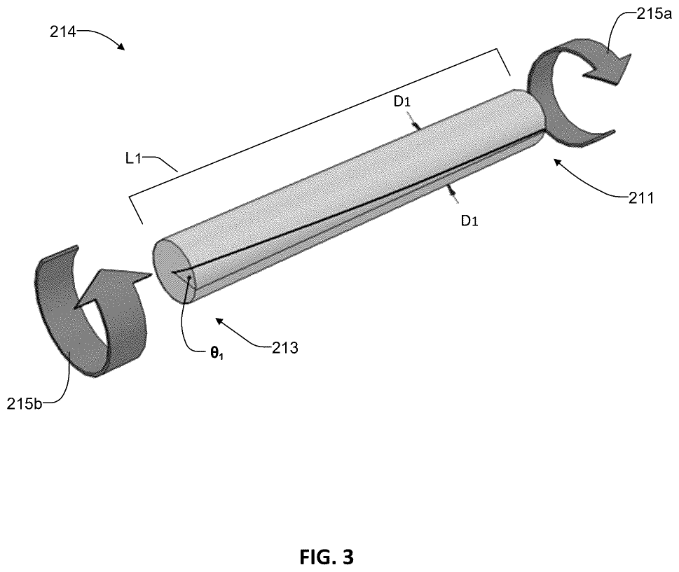

FIG. 3 is a schematic view of a torque tube 214 illustrating a torque tube twist angle θ₁ (generally referred to herein as twist angle θ₁). Although not explicitly shown in FIG. 3, it will be appreciated that the torque tube 214 may be coupled to a plurality of ground piers (e.g., piers 318) by a bearing assembly, such as via a pivot bracket including a pivot pin. The pivot pin may support the torque tube 214 via clamps and optionally mounting brackets. The pivot pin may enable the torque tube 214 to rotate about the axis of the pivot pin, such that an attached solar module may track the sun.

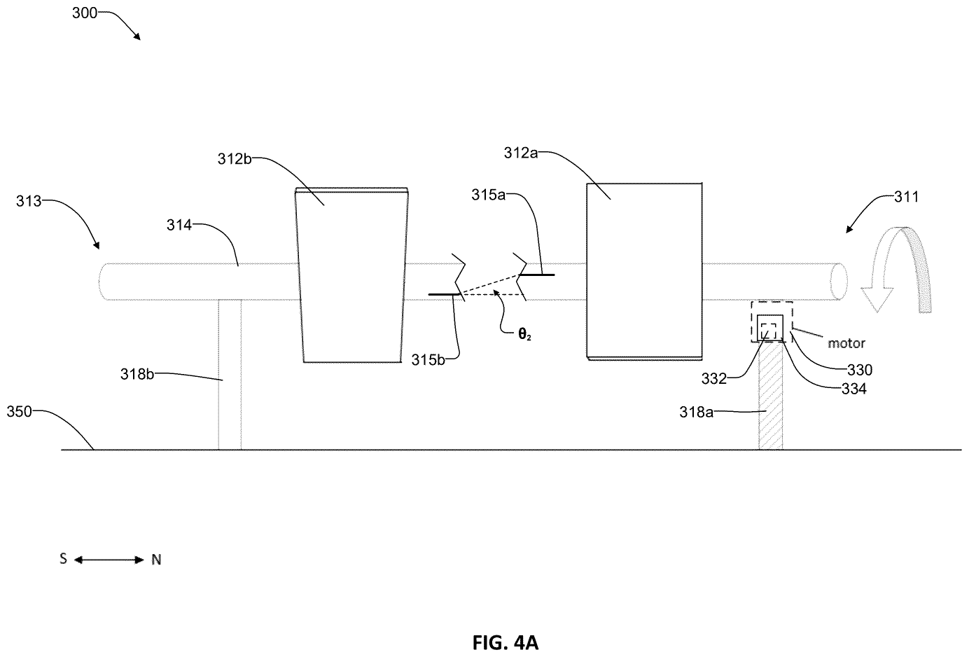

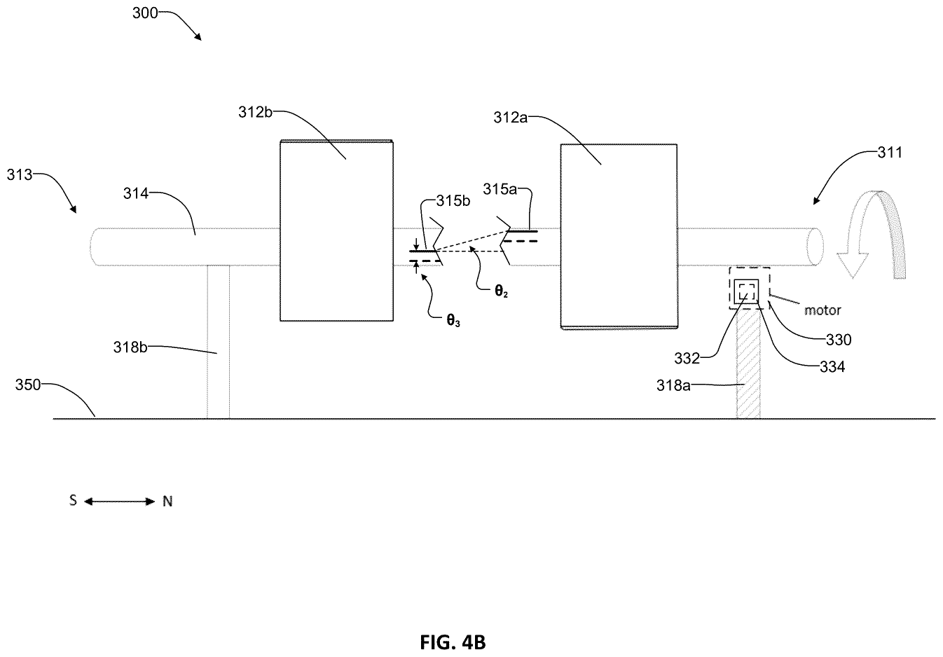

The torque tube 214 may include a first end region 211 and a second end region 213. In some examples, the first end region 211 may include a drive motor, as shown further with reference to FIGS. 4A to 4B. The torque tube 214 may include an outer diameter D₁, a length L₁, and may be formed from a flexible material (e.g., galvanized steel, aluminum, or the like). In some examples, the diameter D₁ of the torque tube 214 may be in a range of about 90 mm to about 125 mm. In some examples, the length L₁ of the torque tube 214 may be in a range of about 140 meters to about 150 meters. In some examples, the length L₁ may be less than 140 meters, greater than 150 meters, or any other length as desired. It is believed that designers will prefer to install solar trackers of greater length in the future. Thus, the torque tubes in such longer installations will also need to be longer.

As will be appreciated, torque may be applied to the torque tube 214, as referenced by arrows 215a, 215b. The amount of torque applied to the torque tube 214 may be significant, for example, dead weight torque (Tdw), e.g., the amount of torque required to begin rotation of the torque tube 214 from a stationary position. The torque applied may cause the torque tube 214 to rotate (e.g., turn) clockwise (arrow 215a) and/or counterclockwise (arrow 215b) over an arc of about 120-degrees to about 140-degrees, and anywhere therebetween as so desired. However, in some examples, the flexibility and the length of the torque tube 214 along with the weight of attached solar modules may cause the torque tube 214 to rotate inconsistently along its length, thereby resulting in increasing twist angles along the length of the torque tube 214. For example, the first end region 211 of the torque tube 214 which may be nearer the drive motor, may rotate a solar module to the desired rotational angle relative to horizontal, and thereby include a twist angle of zero. However, the second end region 213 of the torque tube 214, which may be the furthest from the drive motor, may rotate a solar module beyond the desired rotational angle, thereby advancing in front of the solar module nearer the first end region 211 of the torque tube 214. The rotation beyond the desired rotational angle may create a helical twist of the torque tube 214, resulting in the twist angle θ₁. The twist angle θ₁ may increase gradually along the length of the torque tube 214 from the first end 211 region to the second end region 213 where the twist angle θ₁ is at its greatest. In some examples, the end-of-row twist angle θ₁ will be in a range of approximately 3° to 7.5° The desired rotational angle may be considered as a maximum yield angle. For example, the maximum yield angle may be the angle at which the solar modules (e.g., solar modules 12, 312) maximize sunlight capture. Any twist in the torque tube 214 would result in the solar modules (e.g., solar modules 12, 312) being oriented differently from what is desired, thereby reducing sunlight capture and efficiency of the solar tracker (e.g., solar tracker 10).

FIG. 4A is a schematic view of a solar tracker 300 illustrating a torque tube twist angle θ₂ (generally referred to herein as twist angle θ₂), and FIG. 4B is illustrating the twist angle θ₂ when an offset angle θ₃, according to certain embodiments of the invention, has been applied to the solar tracker 300. It will be appreciated that the left-most solar module of the solar tracker 300 of FIGS. 4A and 4B is located at one end of a solar tracker row (e.g., rows 120a, 120b, 120c, 120d of FIG. 2). It will further be appreciated that the right-most solar module of the solar tracker 300 depicts the location of the motor pier in the solar tracker row, which is often located centrally within the solar tracker row. In other examples, the motor pier in the solar tracker row may be positioned at the other end of the solar tracker row (e.g., an end opposite the left-most solar module in the solar tracker row). The torque tube 314 may be an example of the torque tube 214, as in FIG. 3. As shown in FIGS. 4A to 4B, the solar tracker 300 may include a torque tube 314 arranged in a north-south longitudinal orientation. The torque tube 314 may include a first end region 311 and a second end region 313. The solar tracker 300 may be formed of a plurality of solar modules, which may include a first solar module 312a (e.g., right-most) and a second solar module 312b (e.g., left-most) (generally referred to herein as plurality of solar modules 312), defined by the distance between ground pier support structures 318a, 318b. The ground piers 318a, 318b may be disposed in spaced relation to one another and partially embedded in a ground 350. While it is shown that the solar tracker 300 includes two solar modules 312a, 312b, it will be appreciated that the solar tracker 300 may include thirty solar modules, fifty solar modules, one hundred solar modules, or any other number of solar modules as desired.

In some examples, the solar tracker 300 may include a drive motor 330, which may be positioned on the ground pier 318a adjacent the first end region 311 of the torque tube 314. In some examples, the first solar module 312a of the plurality of solar modules 312 may be located nearest to the drive motor 330, and the second solar module 312b may be a last solar module of the plurality of solar modules 312 and may be located farthest from the drive motor 330. A controller 334 may be operatively coupled to the drive motor 330 and may be configured to operate the drive motor 330 to drive the solar modules 312a, 312b to a desired rotational angle. The controller 334 may include a memory, which stores instructions for performing the methods described herein and operating the drive motor 330, a processor, which may be coupled to the memory and executes the instructions, and a motor driver circuit, which may be coupled to and controlled by the processor according to the executed instructions. The memory may include volatile and non-volatile memory. For example, the memory may include random access memory (RAM) and read-only memory (ROM). The processor may be an application specific integrated circuit (ASIC), a central processing unit (CPU), a microprocessor, or any other suitable circuit for performing the methods described herein and controlling the motor driver based on the instructions stored in memory.

Activation of the drive motor 330 applies torque to the torque tube 314 and rotates the torque tube 314 about an axis of rotation and thus rotates the plurality of solar modules 312 mounted to the torque tube 314 such that the plurality of solar modules 312 can be oriented to a desired position (e.g., desired rotational angle). As previously stated with reference to FIG. 3, the torque applied may cause the torque tube 314 to rotate (e.g., turn) over an arc of about 120-degrees to about 140-degrees, and anywhere therebetween as so desired. However, in some examples, the flexibility over the length of the torque tube 314, which is impacted by the weight of the plurality of solar modules 312, may cause the torque tube 314 to rotate inconsistently along its length, thereby leading to varied rotational angles along the length of the torque tube 314. For example, the first end region 311 of the torque tube 314, which may be closer to the drive motor 330, may rotate the first solar module 312a to a desired rotational angle and thereby have a twist angle of about zero degrees. However, the second end region 313 of the torque tube 314, which may be the furthest from the drive motor 330, may rotate the second solar module 312b beyond the desired rotational angle, thereby advancing in front of the first solar module 312a at the first end region 311 of the torque tube 314, resulting in the relative twist angle θ₂. In some examples, the torque tube twist angle θ₂ may correspond to a twist angle of the second (e.g., last) solar module 312b. As can be seen in FIG. 4A, the twist angle θ₂ may increase gradually along the length of the torque tube 314 from the first end region 311 to the second end region 313 as a distance between the first solar module 312a and the second (e.g., last) solar module 312b increases. Further, the twist angle θ₂ may increase as a number of solar modules between the first solar module 312a and the second (e.g., last) solar module 312b increases. The twist angle θ₂ is at its greatest at the second end region 313 of the torque tube 314, as illustrated by the forward position of the second solar module 312b, and by lines 315a, 315b. The lines 315a, 315b are arbitrary lines shown on the torque tube 314 to further illustrate the twist angle θ₂ of the torque tube 314. In some examples, if the lines 315a, 315b were aligned (e.g., colinear), there would be no twist of the torque tube 314. In some examples, the twist angle θ₂ may be in a range of up to 20° per 100 meters of length of the torque tube 314 from the first end region 311 to the second end region 313. In some examples, the twist angle θ₂ may be in a range of approximately 3° to 7.5°, but the range of the twist angle θ₂ depends on the flexibility and loading configuration of the particular torque tube 314.

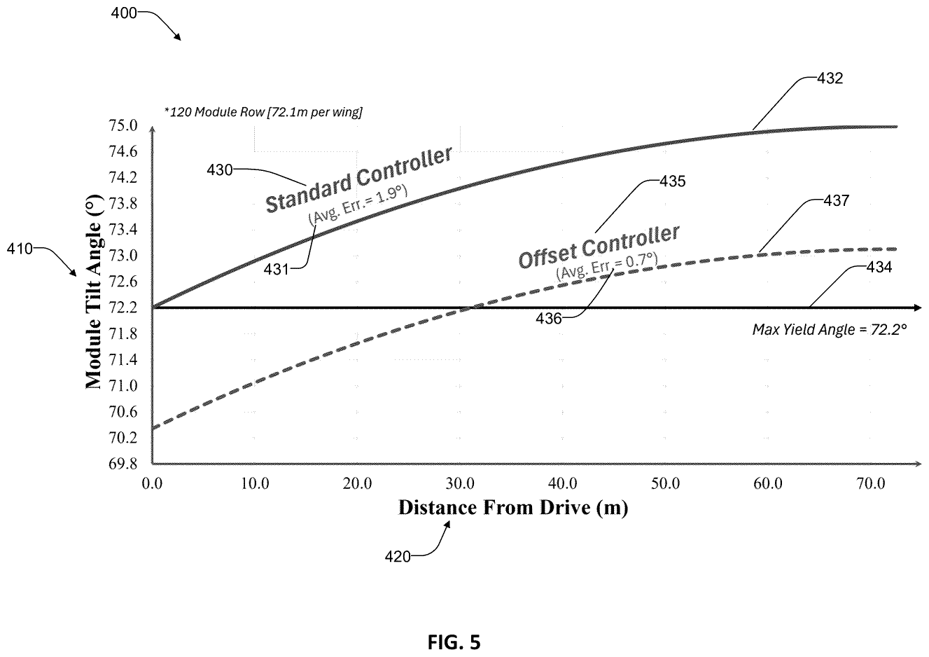

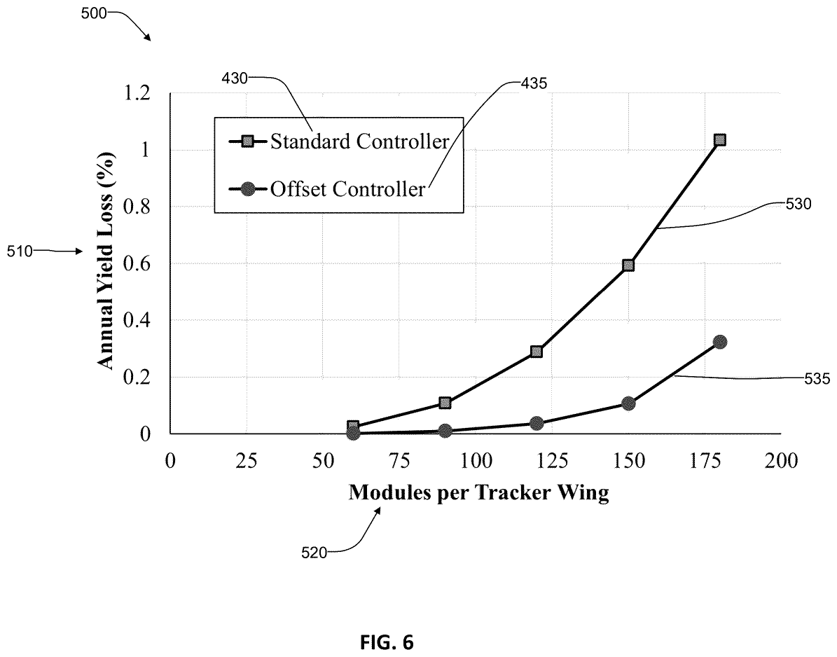

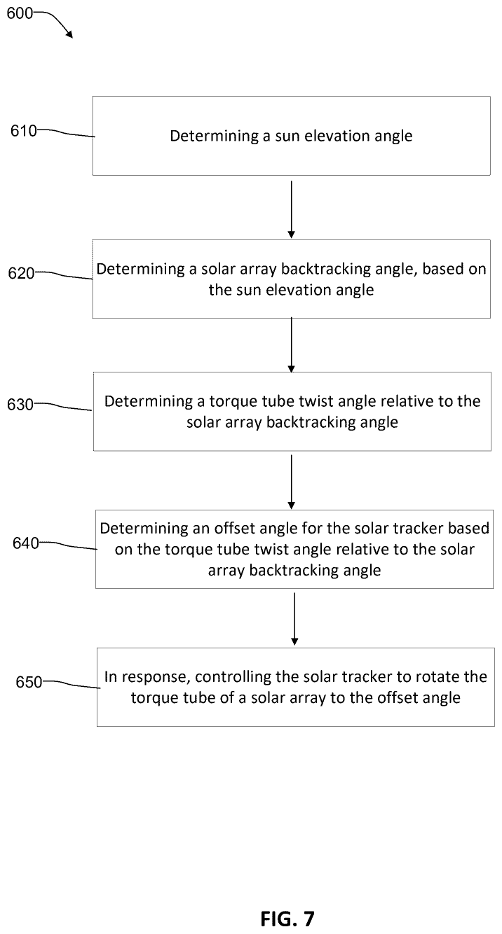

As shown in FIG. 4A, a tilt angle sensor 332 may be positioned at or near the drive motor 330. In some examples, the tilt angle sensor 332 may be positioned within the controller 334. In one example, the controller 334 within the drive motor 330 may be programmed to set the desired tilt angle (e.g., angle of rotation) for the plurality of solar modules 312 at around 72.2-degrees. The desired tilt angle may be set by determining a backtracking angle relative to a sun elevation angle, as described further herein with reference to FIG. 7. The backtracking angle may be an angle at which the solar modules 312a, 312b have been adjusted in response to a position of the sun (e.g., the sun elevation angle) and the geometry of the installation. In some examples, the backtracking angle may correspond to the desired rotational angle. The tilt angle sensor 332 may be configured to sense the tilt angle (e.g., angle of rotation) of the plurality of solar modules 312, and once the desired rotational angle (e.g., 72.2-degrees) of the plurality of solar modules 312 has been reached, the drive motor 330 may be configured to stop rotation of the torque tube 314. With the tilt angle sensor 332 being located at or near the drive motor 330, the tilt angle sensor 332 may only be able to sense the tilt of the solar modules nearest to the tilt angle sensor 332 (e.g., the first solar module 312a). In such examples, while the first solar module 312a may be positioned to the desired rotational angle of 72.2-degrees, the second (e.g., last) solar module 312b may off target in a range of about 0.2-degrees to about 3-degrees. In some examples, the second solar module 312b may be off target by about 2.8-degrees, as indicated by twist angle θ₂. While the example describes a desired rotational angle of 72.2-degrees, it will be appreciated that the desired rotational angle may be any angle of rotation relative to horizontal (e.g., 0-degrees). For example, the desired rotational angle may be in a range of about +75-degrees to about −75-degrees, relative to horizontal. Further, the desired rotational angle may be near the maximum yield angle, as described with reference to FIGS. 5 and 6. However, this is not always the case. In some examples, the desired rotational angle may be less than the maximum yield angle.

In some examples, when the second solar module 312b has been rotated beyond the desired rotational angle, energy production from the solar tracker 300 may be negatively impacted, not only from a lack of the direct sunlight, but also due to shading of an adjacent solar tracker in an adjacent solar tracker row. The shading may be a result of the twist angle θ₂. In an attempt to address one or both of the issues noted above, an angle of rotation of the solar tracker 300 may be modified. In the example shown in FIG. 4A, the rotation of the solar modules 312a, 312b is modified in an attempt to compensate for the twist angle θ₂. However, in such cases, simply adjusting the rotation of the torque tube 314 to match the degree of the twist angle θ₂ may result in the second solar module 312b rotating to the desired rotational angle, while the first solar module 312a may rotate too far behind the desired rotational angle. In such cases, the energy production provided by the first solar module 312a may be negatively impacted.

To accommodate the twist angle θ₂ while simultaneously maximizing the energy production of the solar tracker 300, the drive motor 330 may calculate the offset angle θ₃ and adjust accordingly. The offset angle θ₃ may be the rotational angle adjustment of the first solar module 312a, nearest the drive motor 330, away from the desired rotational angle (e.g., maximum yield angle) that will move an average rotational angle along the length of the torque tube 314 between the first solar module 312a and the second solar module 312b closer to the desired rotational angle (e.g., maximum yield angle). In some examples, the offset angle θ₃ may be a rotational angle adjustment of the first solar module 312a away from the desired rotational angle that will move a calculated average rotational angle between the first solar module 312a and the second (e.g., last) solar module 312b to the desired rotational angle. The offset angle θ₃ may be calculated using the following equation:

$$Offset angle {θ}_{3} = - \frac{1}{3} \frac{{T}_{dw} {L}_{tracker}}{{( G * J )}_{TT}}$$

In the above equation, Tdw is an amount of torque required to begin rotation of the torque tube 314 from a stationary position, which in this case is only the deadweight or gravimetric torque of the solar tracker imbalance about its pivot point. Ltracker represents the length of the torque tube, expressed in meters, G and J each represent different material and geometric properties of the torque tube 314. G represents the modulus of rigidity of the torque tube. J represents the polar moment of inertia of the cross section, and TT represents the torque tube 314. The resulting offset angle θ₃ based on this equation is then used to offset the desired rotational angle. Note that, in the absence of established sign convention, the offset should always reduce the tilt angle of the tracker relative to the ground. Although the offset angle θ₃ is calculated as shown above, it should be understood that the offset angle θ₃ should include ±20% of the calculated offset angle θ₃. In certain designs, a part of the uncertainty (e.g., ±20%) of the offset angle θ₃ is tied to the measurement uncertainty of the controller 334 instrumentation. In other examples, part of the uncertainty (e.g., ±20%) of the offset angle θ₃ results from other static loads present on solar trackers, such as wind, friction, and/or external objects that may modify in situ twist of the torque tube 314 that are not accounted for in the offset angle equation above. The accuracy of the estimated twist (and the yield offset) may improve as the other static loads are accounted for. In some examples, the offset angle equation may be used to determine an improved offset angle θ₃ via substitution of Tdw with the total torque at the drive motor 330, represented by Ttot.

For example, in the example shown in FIG. 4A, the desired rotational angle may be 72.2-degrees, which may be the same as a maximum yield angle. However, the second solar module 312b may rotate beyond the 72.2-degrees due to the length of the torque tube 314 and the weight of the second solar module 312b, resulting in a rotation angle of 75-degrees. In this example, the twist angle θ₂ may be 2.8-degrees. The offset angle θ₃ may then be calculated, and the drive motor 330 may adjust the desired rotational angle to account for the offset angle θ₃. In such cases, as illustrated in FIG. 4B, the first solar module 312a (e.g., nearest the angle of rotation sensor 332) may rotate to slightly less than the maximum yield angle of 72.2-degrees, and the second solar module 312b may rotate to slightly beyond the maximum yield angle of 72.2-degrees, which is described in further detail with reference to FIG. 5. This is further illustrated by the position of the lines 315a, 315b and the dotted lines. As shown in FIG. 4B, the lines 315a, 315b have shifted as the desired rotational angle has been adjusted to account for the offset angle θ₃. The compensation by the offset angle θ₃ is illustrated by the dotted lines, which represent where the lines 315a, 315b were positioned initially (FIG. 4A).

FIG. 5 is a graph 400 showing a module tilt angle 410, measured in degrees, relative to a distance, measured in meters, from a drive motor 420, and FIG. 6 is a graph 500 showing an annual yield loss 510, measured as a percentage, relative to the number of modules per solar tracker. It will be appreciated that the graph 400 and the graph 500 describe data relative to the solar tracker 300 of FIGS. 4A to 4B.

The graph 400 in FIG. 5 illustrates the module tilt angle 410 of a standard controller 430 and an offset controller 435, wherein a torque tube and a solar module may include a starting tilt angle of 70.2-degrees. Further, the twist angle error 431 for the standard controller 430 and the twist angle error 436 for the offset controller 435 is shown. In the example shown in FIG. 5, a maximum yield angle 434 may be determined to be 72.2-degrees. In such an example, the standard controller 430 may set a desired rotational angle at 72.2-degrees. As previously described, a torque tube (e.g., torque tube 314) may rotate and then may stop rotating when a tilt angle sensor (e.g., tilt angle sensor 332) senses that a solar module nearest the tilt angle sensor has reached the desired rotational angle of 72.2-degrees. However, as shown in graph 400, as the distance (in meters) between the drive motor and the solar module and/or a length of the torque tube increases, the module tilt angle 410 also increases, as indicated by line 432. Thus, solar modules at the end of the torque tube may be at a tilt angle of about 75-degrees, which is about 2.8-degrees beyond the maximum yield angle 434 of 72.2-degrees. In this example, the average twist angle error 431 of the standard controller 430 may be about 1.9-degrees.

To compensate or correct for the average twist angle error 431 of the standard controller 430, an offset angle may be calculated using an offset equation. The offset equation is described previously with reference to FIGS. 4A to 4B. In this example, the offset angle has been calculated to be −1.9-degrees. As such, the tilt angle sensor has been updated to reflect this offset angle. For example, while the maximum yield angle 434 remains at 72.2-degrees, the offset controller 435 may update the desired rotational angle to 70.3-degrees to include the offset angle of −1.9-degrees. In this case, the torque tube (e.g., torque tube 314) may rotate and then may stop rotating when the tilt angle sensor (e.g., tilt angle sensor 332) senses that a solar module nearest the tilt angle sensor has reached the desired rotational angle of 70.3-degrees. As shown in the graph 400, while the solar modules nearest the drive motor are −1.9-degrees from the maximum yield angle 434 of 72.2-degrees, a greater number of solar modules are closer to the maximum yield angle 434, as shown by line 437. For example, the solar modules at the end of the torque tube may be at a tilt angle of about 73.0-degrees, which is about 0.8-degrees beyond the maximum yield angle 434. In this example, an average twist angle error 436 of the offset controller 435 may only be about 0.7-degrees. Thus, the offset controller 435 may reduce the average twist angle error 436 by about 63%.

In FIG. 6, the graph 500 shows that the standard controller 430, described relative to FIG. 5, may include an annual yield loss 510 that may exceed 1%, as indicated by line 530. However, by calculating and implementing the offset angle, discussed relative to FIG. 5, the annual yield loss 510 for the offset controller 435 may lower the annual yield loss 510 to less than 0.4%, as indicated by line 535. Further, as shown in FIG. 6, as the number of solar modules per solar tracker row increases, as indicated by modules per tracker wing 520, so does the annual yield loss 510. For example, the annual yield loss 510 at 150 modules per tracker wing 520 may be 0.6% for the standard controller 430, as indicated by line 530. However, by calculating and implementing the offset angle, the annual yield loss 510 at 150 modules per tracker wing 520 may be reduced to 0.1% for the offset controller 435, as indicated by line 535.

FIG. 7 is a flow chart illustrating a method 600 of controlling a solar tracker in accordance with the present disclosure, e.g., solar tracker 300. In some examples, the sun elevation angle may be determined at a controller (e.g., controller 334), as referenced by block 610. Based upon the sun elevation angle, a solar array backtracking angle may be determined at the controller, as referenced by block 620. As discussed elsewhere herein, the backtracking angle may be an angle at which the solar modules (e.g., solar modules 312a, 312b) have been adjusted in response to a position of the sun (e.g., the sun elevation angle) and the geometry of the installation. As discussed, the flexibility over the length of a torque tube (e.g., torque tube 314), which is impacted by the weight and number of solar modules of the plurality of solar modules, may cause the torque tube to rotate inconsistently along its length, thereby leading to varied rotational angles along the length of the torque tube. For example, a first end region of the torque tube, which may be closer to a drive motor, may rotate a first solar module to a desired rotational angle and thereby the first end region of the torque tube and the first solar module may have a twist angle of about zero degrees. However, a second end region of the torque tube, which may be the furthest from the drive motor, may rotate a second solar module beyond the desired rotational angle, thereby advancing in front of the first solar module. This results in a torque tube twist, having a torque tube twist angle. The torque tube twist angle may be determined relative to the solar array backtracking angle, at the controller, as referenced by block 630.

To accommodate the twist angle, an offset angle may be calculated based on the torque tube twist angle relative to the solar array backtracking angle, at the controller, as referenced by block 640. In response, the controller (e.g., controller 334) may control the solar tracker, rotating the torque tube of the solar tracker of the solar array to the offset angle, as referenced by block 650. As discussed elsewhere herein, the offset angle (e.g., offset angle θ₃) may be the rotational angle of the first solar module nearest the drive motor away from the desired rotational angle (e.g., maximum yield angle) that will provide the average rotational angle along the length of the torque tube to be the nearer the desired rotational angle (e.g., maximum yield angle). The offset angle may be calculated using the following equation, as described herein with reference to FIGS. 4A and 4B:

$$Offset angle {θ}_{3} = - \frac{1}{3} \frac{{T}_{dw} {L}_{tracker}}{{( G * J )}_{TT}}$$

It will be appreciated that the sun elevation angle, the solar array backtracking angle, the torque tube twist angle, and the offset angle may each be determined either inside a controller (e.g., controller 334) or outside of the controller. If the determinations are made outside of the controller, the controller may then be programmed to run the solar tracker using the determined offset angle.

As previously discussed, torque tube twist is a common issue present in the solar tracker industry. The offset algorithm disclosed herein may help mitigate the problem where it is present.

Various non-limiting exemplary embodiments have been described. It will be appreciated that suitable alternatives are possible without departing from the scope of the examples described herein.

1. A solar tracker system comprising:
a plurality of solar tracker rows, a one of the plurality of solar tracker rows including:
a plurality of support piers;
a torque tube extending along the solar tracker row rotatably supported on the plurality of support piers;
a plurality of solar modules coupled to the torque tube; and
a drive motor configured to cause the torque tube to rotate; and
a controller configured to:
determine a sun elevation angle;
determine a desired rotational angle of the plurality of solar modules based on the sun elevation angle;
determine a torque tube twist angle for the one of the solar tracker rows using the desired rotational angle;
determine an offset angle for the one of the solar tracker rows based on the torque tube twist angle; and
in response to determining the offset angle, controlling the one of the solar tracker rows to rotate the torque tube to the desired rotational angle adjusted by the offset angle.

2. The solar tracker system of claim 1, wherein a first solar module of the plurality of solar modules is located nearest to the drive motor and a last solar module of the plurality of solar modules is located farthest from the drive motor.

3. The solar tracker system of claim 2, wherein the torque tube twist angle corresponds to a twist angle of the last solar module.

4. The solar tracker system of claim 3, wherein the torque tube twist angle increases as the distance between the first solar module and the last solar module increases.

5. The solar tracker system of claim 3, wherein the torque tube twist angle increases as a number of solar modules between the first solar module and the last solar module increases.

6. The solar tracker system of claim 3, wherein the torque tube twist angle is in a range of 0.2-degrees to 3-degrees.

7. The solar tracker system of claim 2, wherein the first solar module of the plurality of solar modules has a twist angle of zero-degrees.

8. The solar tracker system of claim 2, wherein the offset angle is a rotational angle adjustment of the first solar module away from the desired rotational angle that will move an average rotational angle between the first solar module and the last solar module closer to the desired rotational angle.

9. The solar tracker system of claim 2, wherein the offset angle is a rotational angle adjustment of the first solar module away from the desired rotational angle that will move a calculated average rotational angle between the first solar module and the last solar module to the desired rotational angle.

10. The solar tracker system of claim 1, wherein determining the offset angle includes evaluating the following expression:
$$Offset angle {θ}_{3} = - \frac{1}{3} \frac{{T}_{dw} {L}_{tracker}}{{( G * J )}_{TT}}$$
where Tdw represents deadweight torque, Ltracker represents a length of the torque tube, G represents a modulus of rigidity of the torque tube, and J represents a polar moment of inertia of a cross section of the torque tube.

11. The solar tracker system of claim 10, wherein deadweight torque is an amount of torque required to begin rotation of the torque tube from a stationary position.

12. The solar tracker system of claim 10, wherein the offset angle includes ±20% of the calculated offset angle θ.

13. The solar tracker system of claim 1, wherein the desired rotational angle corresponds to a calculated backtracking angle.

14. A method of controlling a solar tracker via a controller having a memory with instructions for determining an offset angle stored thereon, the method comprising:
determining a sun elevation angle, at the controller;
determining a solar array backtracking angle based on the sun elevation angle, at the controller;
determining a torque tube twist angle relative to the solar array backtracking angle, at the controller;
determining the offset angle for the solar tracker based on the torque tube twist angle relative to the solar array backtracking angle, at the controller; and
in response to determining the offset angle for the solar tracker, controlling the solar tracker, via the controller, to rotate a torque tube of a solar array to the offset angle.

15. The method of claim 14, wherein determining the offset angle includes evaluating the following expression:
$$Offset angle {θ}_{3} = - \frac{1}{3} \frac{{T}_{dw} {L}_{tracker}}{{( G * J )}_{TT}}$$
where Tdw represents deadweight torque, Ltracker represents a length of the torque tube, G represents a modulus of rigidity of the torque tube, J represents a polar moment of inertia of a cross section of the torque tube, and TT represents the torque tube.

16. The method of claim 15, wherein deadweight torque is an amount of torque required to begin rotation of the torque tube from a stationary position.

17. The method of claim 14, wherein the torque tube twist angle is 0-degrees near a drive motor.

18. The method of claim 17, wherein the torque tube twist angle increases along a length of the torque tube due to an increased length of the torque tube and a weight of a plurality of solar modules of the solar array.

19. The method of claim 15, wherein the offset angle includes ±20% of the calculated offset angle θ.

20. The method of claim 15, wherein the determined backtracking angle corresponds to a desired rotational angle.
